(19) United States
(12) Patent Application Publication
(10) Pub. No.: US 2013/0084384 A1
(43) Pub. Date: Apr. 4, 2013

(54) MANUFACTURING METHOD OF SECONDARY PARTICLES AND MANUFACTURING METHOD OF ELECTRODE OF POWER STORAGE DEVICE

(71) Applicant: Semiconductor Energy Laboratory Co., Ltd., Atsugi-shi (JP)

(72) Inventor: Masaki YAMAKAJI, Atsugi (JP)

(73) Assignee: SEMICONDUCTOR ENERGY LABORATORY CO., LTD., Atsugi-shi (JP)

(21) Appl. No.: 13/628,223

(22) Filed: Sep. 27, 2012

(30) Foreign Application Priority Data
Oct. 4, 2011 (JP) 2011-219787

(51) Int. Cl. H01M 4/04; H01B 1/00; H01B 1/04; B82Y 30/00; B82Y 40/00

(52) U.S. Cl. 427/122; 252/500; 252/502; 252/521.2; 252/521.3; 252/520.21; 427/58; 427/126.1; 977/842; 977/948

(57) ABSTRACT

The conductivity of an active material layer provided in an electrode of a secondary battery is sufficiently increased and active material powders in a slurry containing active materials each have a certain size. Secondary particles are manufactured through the following steps: mixing at least active material powders and oxidized conductive material powders to form a slurry; drying the slurry to form a dried substance; grinding the dried substance to form a powder mixture; and reducing the powder mixture. Further, an electrode of a power storage device is manufactured through the following steps: forming a slurry containing at least the secondary particles; applying the slurry to a current collector; and drying the slurry over the current collector.

### BACKGROUND OF THE INVENTION

1. Field of the Invention

The present invention relates to a manufacturing method of secondary particles and a manufacturing method of an electrode of a power storage device using the secondary particles.

Note that, in this specification, the power storage device refers to every element and every device which have a function of storing power.

2. Description of the Related Art

Electronic devices having high portability such as laptop personal computers and cellular phones have progressed significantly. An example of a power storage device suitable for an electronic device having high portability is a lithium-ion secondary battery.

An electrode of the lithium-ion secondary battery includes an active material over a current collector. As a positive electrode active material, a phosphate compound having an olivine structure and containing lithium (Li) and iron (Fe), manganese (Mn), cobalt (Co), or nickel (Ni), such as lithium iron phosphate (LiFePO₄), lithium manganese phosphate (LiMnPO₄), lithium cobalt phosphate (LiCoPO₄), or lithium nickel phosphate (LiNiPO₄), has been known for example. High capacity can be safely achieved with lithium iron phosphate since iron phosphate which is formed by completely taking lithium from lithium iron phosphate is also stable. It is known that use of lithium iron phosphate whose particle size is reduced to approximately 50 nm as the positive electrode active material dramatically improves a charging and discharging rate (Non-Patent Document 1).

### REFERENCE

### Non-Patent Document

[Non-Patent Document 1] B. Kang et al., “Battery materials for ultrafast charging and discharging,” Nature, 12 Mar. 2009, Vol. 458, pp. 190-193

### SUMMARY OF THE INVENTION

However, if powders that are used as the active materials each have an ultra small diameter, in a drying step performed after a slurry containing the active materials is applied to a current collector, heating causes convection in the slurry and the active materials are aggregated. The difference in the film thickness between a region where the active materials are aggregated and the other region is large, and the region having a small film thickness crack; thus, it is difficult to form an active material layer thick. For this reason, it is difficult to increase a power storage capacity per battery. Therefore, the diameters of the powders contained as the active materials (active material powders) each need to have a certain size. One of methods of making each of the active material powders have a certain size is to process the active material powders to form secondary particles.

In addition, the secondary particles containing the active materials need to be manufactured so that the active material layer provided in an electrode has sufficiently high conductivity.

An object of one embodiment of the present invention is to sufficiently increase the conductivity of an active material layer provided in an electrode of a secondary battery and to make each of active material powders in a slurry containing active materials have a certain size.

An object of one embodiment of the present invention is to sufficiently increase the conductivity of an active material layer provided in an electrode of a secondary battery and to manufacture an electrode by applying a slurry containing active materials without using a conductive additive.

One embodiment of the present invention is a manufacturing method of secondary particles which includes the following steps: mixing at least active material powders and oxidized conductive material powders to form a slurry; drying the slurry to form a dried substance; grinding the dried substance to form a powder mixture; and reducing the powder mixture.

One embodiment of the present invention is a manufacturing method of an electrode of a power storage device using the secondary particles having the structure obtained by the above method. In other words, one embodiment of the present invention is a manufacturing method of an electrode of a power storage device which includes the following steps: mixing at least active material powders and oxidized conductive material powders to form a first slurry; drying the first slurry to form a dried substance; grinding the dried substance to form a powder mixture; reducing the powder mixture to form secondary particles; forming a second slurry containing at least the secondary particles; applying the second slurry to a current collector; and drying the second slurry over the current collector.

One embodiment of the present invention is a manufacturing method of an electrode of a power storage device, which includes the following steps: mixing at least active material powders and oxidized conductive material powders to form a first slurry; drying the first slurry to form a dried substance; grinding the dried substance to form a powder mixture; reducing the powder mixture to form secondary particles; extracting secondary particles within a predetermined particle size range from the secondary particles; forming a second slurry containing at least the secondary particles within the predetermined particle size range; applying the second slurry to a current collector; and drying the second slurry over the current collector.

Note that, in this specification, a particle size is the major axis of a rectangular parallelepiped circumscribing a particle.

In the above structure, specifically, the predetermined particle size range of the secondary particles is preferably greater than or equal to 3 μm and less than 10 μm.

In the above structure, one example of the conductive material is graphene.

In the above structure, as examples of the active material, lithium iron phosphate, lithium manganese silicate, and lithium titanate can be given.

Temperatures during steps for manufacturing the secondary particles having above structure using lithium iron phosphate, lithium manganese silicate, or lithium titanate or for manufacturing the electrode of the power storage device, typically, temperatures at which the first and second slurries are dried, are preferably lower than a temperature at which grain growth of the active material begins to occur. This is because lithium iron phosphate, lithium manganese silicate, and lithium titanate have low conductivity; thus, the occupancy of the active material in a current path increases due to the grain growth of the active material, and the conductivity of the active material layer itself further decreases as compared to that before the grain growth of the active material occurs. Such active material with low conductivity may have a small particle size of greater than or equal to 20 nm and less than or equal to 300 nm. Having conductive materials formed by reducing the oxidized conductive material powders among the active materials enables the active material layer itself to maintain high conductivity.

According to one embodiment of the present invention, the conductivity of an active material layer provided in an electrode of a secondary battery can be sufficiently increased and each of active material powders in a slurry containing active materials can have a certain size.

Note that, according to one embodiment of the present invention, an electrode can be manufactured by applying the slurry containing the active materials that enables charge and discharge without using a conductive additive.

### BRIEF DESCRIPTION OF THE DRAWINGS

FIGS. 1A to 1E illustrate a manufacturing method of secondary particles of one embodiment of the present invention.

FIGS. 2A to 2D illustrate a manufacturing method of an electrode of a power storage device of one embodiment of the present invention.

FIG. 3 illustrates an example of a power storage device of one embodiment of the present invention.

### DETAILED DESCRIPTION OF THE INVENTION

Embodiments and example of the present invention will be described below with reference to the drawings. Note that the invention is not limited to the following description, and it will be easily understood by those skilled in the art that various changes and modifications can be made without departing from the spirit and scope of the invention. Thus, the present invention should not be interpreted as being limited to the following description of the embodiments. In description with reference to the drawings, in some cases, the same reference numerals are used in common for the same portions in different drawings. Further, in some cases, the same hatching patterns are applied to similar parts, and the similar parts are not necessarily designated by reference numerals.

### Embodiment 1

In this embodiment, a manufacturing method of secondary particles which is one embodiment of the present invention and a manufacturing method of an electrode of a power storage device using the secondary particles will be described with reference to drawings. Note that, in this embodiment, “primary particles”, a counterpart of secondary particles, are active material powders.

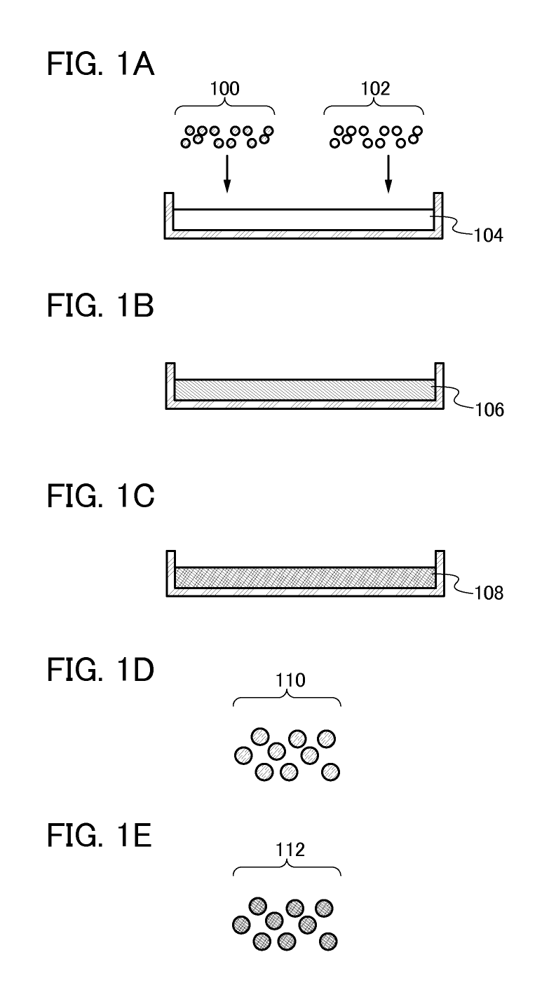

First, a method for manufacturing secondary particles is described. Active material powders 100 and oxidized conductive material powders 102 are mixed with a dispersion medium 104, so that a first slurry 106 is formed (FIGS. 1A and 1B).

Examples of the material for the active material powders 100 include lithium iron phosphate, lithium manganese silicate, and lithium titanate. Lithium iron phosphate, lithium manganese silicate, and lithium titanate have low conductivity. However, after mixing active material powders and oxidized conductive material powders, reduction in diameter is performed, the oxidized conductive material powders are reduced to form secondary particles, and an active material layer is formed using the secondary particles; thus, the conductivity of the active material layer provided in an electrode can be sufficiently increased.

The oxidized conductive material powders 102 may be oxidized conductive materials that are comminuted. One example of a conductive material used for forming the oxidized conductive material powders 102 is graphene. Examples of the oxidized conductive material powders 102 include graphene oxide.

The dispersion medium 104 needs to enable oxidized conductive material powders to be dispersed therein, and a polar solvent may be used, for example. As the polar solvent, N-methylpyrrolidone (NMP) or water may be used, for example.

The first slurry 106 may be formed by uniformly dispersing the active material powders 100 and the oxidized conductive material powders 102 in the dispersion medium 104. By putting the oxidized conductive material powders 102 in the slurry 106, the interaction between the active material powders 100 and the functional group of the oxidized conductive material powders 102 can promote formation of secondary particles.

Next, the first slurry 106 is dried to form a dried substance 108 (FIG. 1C).

The dried substance 108 may be formed by a method by which the first slurry 106 can be dried. The dried substance 108 can be formed, for example, by performing heat drying on the first slurry 106 at a temperature higher than or equal to 70° C. and lower than or equal to 100° C., and then drying it at 100° C. under reduced pressure.

Next, the dried substance 108 is ground so that a powder mixture 110 is formed (FIG. 1D).

For the powder mixture 110, the active material powders 100 and the oxidized conductive material powders 102 may be uniformly mixed.

Next, the oxidized conductive material powders 102 included in the powder mixture 110 are reduced so that secondary particles 112 are formed (FIG. 1E).

For the secondary particles 112, oxygen may be removed from the oxidized conductive material powders 102 included in the powder mixture 110. Note that oxygen may partly remains in the secondary particles 112.

In the above-described manner, the secondary particles 112 can be formed.

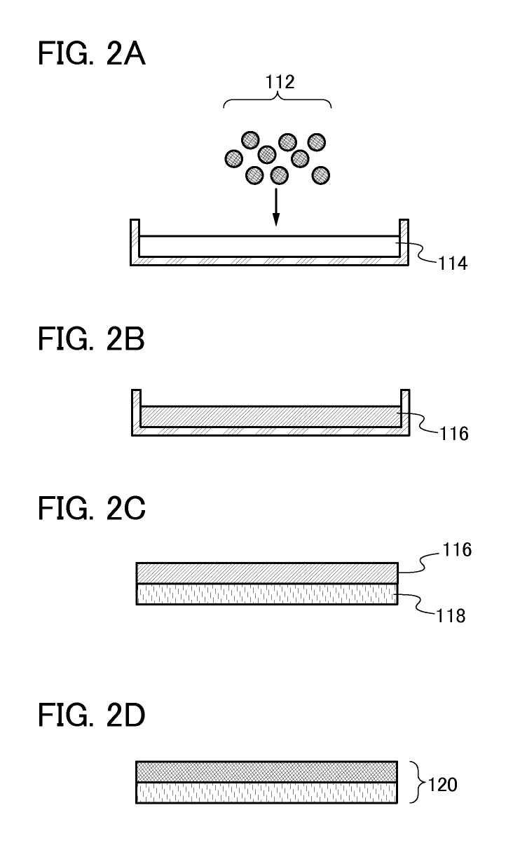

A second slurry 116 is formed by mixing the secondary particles 112 thus formed and a dispersion medium 114 (FIGS. 2A and 2B).

For the dispersion medium 114, the same material as that of the dispersion medium 104 can be used.

Note that, for the second slurry 116, the secondary particles 112 and a binder may be uniformly dispersed in the dispersion medium 114. Examples of the binder include polyvinylidene fluoride (PVDF).

Note that, before the second slurry 116 is formed, it is preferable to limitedly extract secondary particles within a predetermined particle size range from the obtained secondary particles. This is because the secondary particles 112 can each have a uniform particle size and variations in conductivity of the active material layer can be suppressed. For extraction, a classifier may be used, for example.

Here, it is preferable that the predetermined particle size range of the secondary particles 112 is greater than or equal to 3 μm and less than 10 μm. In this case, for example, after secondary particles whose particle sizes are less than 10 μm are extracted with the use of a sieve with an aperture size of 10 μm, secondary particles whose particle sizes are greater than or equal to 3 μm and less than 10 μm can be extracted with the use of a sieve with an aperture size of 3 μm. Alternatively, for example, after secondary particles whose particle sizes are greater than or equal to 3 μm with the use of a sieve with an aperture size of 3 μm, secondary particles whose particle sizes are greater than or equal to 3 μm and less than 10 μm can be extracted with the use of a sieve with an aperture size of 10 μm.

Next, the second slurry 116 is applied to a current collector 118 (FIG. 2C).

Next, the second slurry 116 over the current collector 118 is dried to form an electrode 120 (FIG. 2D).

Here, drying of the second slurry 116 may be performed in a manner similar to that of the first slurry 106. The electrode 120 can be formed, for example, by performing heat drying on the second slurry 116 at a temperature higher than or equal to 70° C. lower than or equal to 100° C., and then drying it at 170° C. under reduced pressure.

The current collector 118 may be formed of a conductive material that functions as a current collector. Examples of the current collector 118 include titanium foil, aluminum foil, and stainless steel plate.

In the above-described manner, the secondary particles can be manufactured and an electrode of a secondary battery can be manufactured using the secondary particles.

Note that, in this embodiment, the temperature of each step is lower than a temperature at which the grain growth of the active material included in the active material powders 100 occurs. This is because lithium iron phosphate, lithium manganese silicate, and lithium titanate, which are listed above as the materials for the active material powders 100, have low conductivity; thus, the occupancy of the active material in a current path increases due to the grain growth of the active material, and the conductivity of the active material layer of the electrode 120 itself decreases.

Such active material with low conductivity may have a small particle size of greater than or equal to 20 nm and less than or equal to 300 nm. Having conductive materials formed by reducing the oxidized conductive material powders among the active materials enables the active material layer of the electrode 120 itself to maintain high conductivity.

Note that the grain growth of lithium iron phosphate occurs at 600° C.; thus, the temperature of each step is at least lower than 600° C.

Furthermore, by setting the temperature of each step as low as possible in this manner, throughput can be improved and manufacturing cost can be reduced.

### Embodiment 2

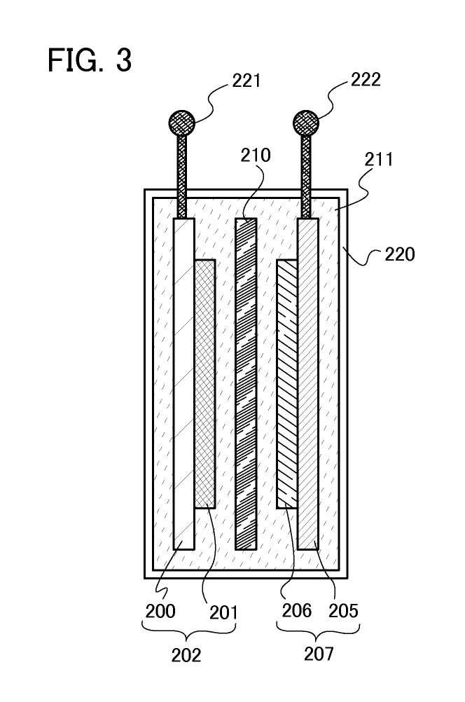

In this embodiment, a power storage device using the electrode obtained by the manufacturing method described in Embodiment 1 will be described taking a lithium-ion secondary battery as one example. FIG. 3 is a schematic cross-sectional view of a lithium-ion secondary battery of this embodiment.

In the lithium-ion secondary battery illustrated in FIG. 3, a positive electrode 202, a negative electrode 207, and a separator 210 are provided in a housing 220 which is isolated from the outside, and an electrolyte solution 211 is filled in the housing 220. The separator 210 is provided between the positive electrode 202 and the negative electrode 207.

In the positive electrode 202, a positive electrode active material layer 201 is provided in contact with a positive electrode current collector 200. In this specification, the positive electrode active material layer 201 and the positive electrode current collector 200 over which the positive electrode active material layer 201 is provided are collectively referred to as the positive electrode 202.

On the other hand, a negative electrode active material layer 206 is provided in contact with a negative electrode current collector 205. In this specification, the negative electrode active material layer 206 and the negative electrode current collector 205 over which the negative electrode active material layer 206 is provided are collectively referred to as the negative electrode 207.

A first electrode 221 and a second electrode 222 are connected to a positive electrode current collector 200 and a negative electrode current collector 205, respectively, and charge and discharge are performed by the first electrode 221 and the second electrode 222.

Although, in the illustrated structure, there are gaps between the positive electrode active material layer 201 and the separator 210 and between the negative electrode active material layer 206 and the separator 210, one embodiment of the present invention is not limited to this structure. The positive electrode active material layer 201 may be in contact with the separator 210, and the negative electrode active material layer 206 may be in contact with the separator 210. Further, the lithium ion battery may be rolled into a cylinder with the separator 210 provided between the positive electrode 202 and the negative electrode 207.

Note that, as the negative electrode current collector 205, a material having high conductivity such as copper, stainless steel, iron, or nickel may be used.

As a material of the negative electrode active material layer 206, lithium, aluminum, graphite, silicon, germanium, or the like is used. The negative electrode active material layer 206 may be formed over the negative electrode current collector 205 by a coating method, a sputtering method, a vacuum evaporation method, or the like. It is possible to omit the negative electrode current collector 205 and use the negative electrode active material layer 206 alone for a negative electrode. Note that the theoretical lithium occlusion capacity is higher in germanium and silicon than in graphite. When the lithium occlusion capacity is high, charge and discharge can be performed sufficiently even in a small area and downsizing of a power storage device can be realized. Further, cost reduction can be also realized.

The electrolyte solution 211 is a liquid containing ions which function to transfer charge. In a lithium-ion secondary battery, lithium ions are used as ions which function to transfer charge. However, one embodiment of the invention is not limited thereto, a secondary battery may be manufactured using a liquid containing any other alkali metal ion or an alkaline earth metal ion. Examples of the alkali metal ion include a lithium ion, a sodium ion, and a potassium ion. Examples of the alkaline earth metal ion include a beryllium ion, a magnesium ion, a calcium ion, a strontium ion, and a barium ion.

The electrolyte solution 211 includes, for example, a solvent and a lithium salt or a sodium salt dissolved therein. Examples of the lithium salt include LiCl, LiF, LiClO₄, LiBF₄, LiAsF₆, LiPF₆ and Li(C₂F₅SO₂)₂N. Examples of the sodium salt include NaCl, NaF, NaClO₄, and NaBF₄.

Examples of the solvent for the electrolyte solution 211 include cyclic carbonates (e.g., ethylene carbonate (hereinafter abbreviated to EC), propylene carbonate (PC), butylene carbonate (BC), and vinylene carbonate (VC)); acyclic carbonates (e.g., dimethyl carbonate (DMC), diethyl carbonate (DEC), ethylmethyl carbonate (EMC), methylpropyl carbonate (MPC), isobutyl methyl carbonate, and dipropyl carbonate (DPC)); aliphatic carboxylic acid esters (e.g., methyl formate, methyl acetate, methyl propionate, and ethyl propionate); acyclic ethers (e.g., 1,2-dimethoxyethane (DME), 1,2-diethoxyethane (DEE), ethoxymethoxy ethane (EME), and γ-lactones such as γ-butyrolactone); cyclic ethers (e.g., tetrahydrofuran and 2-methyltetrahydrofuran); cyclic sulfones (e.g., sulfolane); alkyl phosphate ester (e.g., dimethylsulfoxide and 1,3-dioxolane, and trimethyl phosphate, triethyl phosphate, and trioctyl phosphate); and fluorides thereof. All of the above solvents can be used either alone or in combination as the electrolyte solution 211.

As the separator 210, paper, nonwoven fabric, a glass fiber, or a synthetic fiber such as nylon (polyamide), vinylon (also called vinalon) (a polyvinyl alcohol based fiber), polyester, acrylic, polyolefin, polyurethane, and the like may be used. Note that the separator 210 needs to be insoluble in the electrolyte solution 211.

More specific examples of materials for the separator 210 are high-molecular compounds based on fluorine-based polymer, polyether such as polyethylene oxide and polypropylene oxide, polyolefin such as polyethylene and polypropylene, polyacrylonitrile, polyvinylidene chloride, polymethyl methacrylate, polymethylacrylate, polyvinyl alcohol, polymethacrylonitrile, polyvinyl acetate, polyvinylpyrrolidone, polyethyleneimine, polybutadiene, polystyrene, polyisoprene, and polyurethane, derivatives thereof, cellulose, paper, and nonwoven fabric, all of which can be used either alone or in a combination.

At the time of charge, a positive-electrode terminal is connected to the first electrode 221 and a negative-electrode terminal is connected to the second electrode 222. An electron is taken away from the positive electrode 202 through the first electrode 221 and transferred to the negative electrode 207 through the second electrode 222. In addition, a lithium ion is eluted from the positive electrode active material in the positive electrode active material layer 201 from the positive electrode 202, reaches the negative electrode 207 through the separator 210, and is taken in the negative electrode active material in the negative electrode active material layer 206. Then, the lithium ion and the electron are combined in the surface of the negative electrode active material layer 206 or in the vicinity thereof and are occluded in the negative electrode active material layer 206. At the same time, in the positive electrode active material layer 201, an electron is released outside from the positive electrode active material, and an oxidation reaction of a transition metal (one or more of iron, manganese, cobalt, and nickel) contained in the positive electrode active material occurs.

At the time of discharge, in the negative electrode 207, the negative electrode active material layer 206 releases lithium as an ion, and an electron is transferred to the second electrode 222. The lithium ion passes through the separator 210, reaches the positive electrode active material layer 201, and is taken in the positive electrode active material in the positive electrode active material layer 201. At that time, an electron from the negative electrode 207 also reaches the positive electrode 202, and a reduction reaction of the transition metal (one or more of iron, manganese, cobalt, and nickel) contained in the positive electrode active material occurs.

As described above, by using the electrode manufactured by the manufacturing method of an electrode, which is described in Embodiment 1, a lithium-ion secondary battery can be manufactured.

### EXAMPLE

In this example, an example of the method for manufacturing an electrode, which is described in Embodiment 1, is described.

As the active material powders 100, lithium iron phosphate powders were used.

As the oxidized conductive material powders 102, graphene oxide powders were used.

As the dispersion medium 104, NMP was used.

First, the lithium iron phosphate powders and the graphene oxide powders, where the weight ratio was 91.4:8.6, were mixed with water to form the first slurry 106. Then, the first slurry 106 is dried in an atmosphere where the pressure is lower than or equal to 0.01 MPa and the temperature is 100° C. to form the dried substance 108.

Next, the dried substance 108 was ground to form the powder mixture 110, the powder mixture 110 was reduced in an atmosphere where the pressure is lower than or equal to 0.01 MPa and the temperature is 300° C. to form the secondary particles 112, and secondary particles whose particle sizes were approximately less than 10 μm were extracted with the use of a sieve with an aperture size of approximately 10 μm. Next, secondary particles whose particle sizes were greater than or equal to 3 μm and less than 10 μm were extracted with the use of a sieve with an aperture size of approximately 3 μm.

Then, the extracted secondary particles 112 and PVDF were mixed with the dispersion medium 114 to form the second slurry 116, and the second slurry 116 was applied to aluminum foil, so that an electrode was formed. Note that the weight ratio of the secondary particles 112 to PVDF was set at 92.7:7.3.

In this manner, the electrode of this example can be manufactured without using a conductive additive.

This application is based on Japanese Patent Application serial no. 2011-219787 filed with the Japan Patent Office on Oct. 4, 2011, the entire contents of which are hereby incorporated by reference.

What is claimed is:

1. A manufacturing method of particles, comprising the steps of:
mixing at least active material powders and oxidized conductive material powders to form slurry;
drying the slurry to form a dried substance;
grinding the dried substance to form a powder mixture; and
reducing the powder mixture.

2. The manufacturing method according to claim 1, wherein the conductive material comprises graphene.

3. The manufacturing method according to claim 1, wherein an active material in the active material powders comprises any one of lithium iron phosphate, lithium manganese silicate, and lithium titanate.

4. The manufacturing method according to claim 1, wherein a temperature at which the slurry is dried is lower than a temperature at which grain growth of an active material in the active material powders begins to occur.

5. A manufacturing method of an electrode of a power storage device, comprising the steps of:
mixing at least active material powders and oxidized conductive material powders to form first slurry;
drying the first slurry to form a dried substance;
grinding the dried substance to form a powder mixture;
reducing the powder mixture to form particles;
forming second slurry containing at least the particles;
applying the second slurry to a current collector; and
drying the second slurry over the current collector.

6. The manufacturing method according to claim 5, wherein an active material in the active material powders comprises any one of lithium iron phosphate, lithium manganese silicate, and lithium titanate.

7. The manufacturing method according to claim 5, wherein temperatures at which the first and second slurries are dried are lower than a temperature at which grain growth of an active material in the active material powders begins to occur.

8. A manufacturing method of an electrode of a power storage device, comprising the steps of:
mixing at least active material powders and oxidized conductive material powders to form first slurry;
drying the first slurry to form a dried substance;
grinding the dried substance to form a powder mixture;
reducing the powder mixture to form secondary particles;
extracting secondary particles within a predetermined particle size range from the secondary particles;
forming second slurry containing at least the secondary particles whose particle sizes are greater than or equal to 3 μm and less than 10 μm;
applying the second slurry to a current collector; and
drying the second slurry over the current collector.

9. The manufacturing method according to claim 8, wherein the conductive material comprises graphene.

10. The manufacturing method according to claim 8, wherein an active material in the active material powders comprises any one of lithium iron phosphate, lithium manganese silicate, and lithium titanate.

11. The manufacturing method according to claim 8, wherein temperatures at which the first and second slurries are dried are lower than a temperature at which grain growth of an active material in the active material powders begins to occur.
